(19) United States
(12) Patent Application Publication
(10) Pub. No.: US 2011/0010941 A1
(43) Pub. Date: Jan. 20, 2011

(54) NOSE HAIR TRIMMER WITH DUAL CUTTING EDGES

(75) Inventors: Tung Yan LAU, Fotan (HK); Ming Kuen Leung, Fontan (HK)

Correspondence Address: Specialife Industries Limited, Room 406, 4/F., Wah Yiu Industrial Centre, 30-32 Au Pui Wan Street, Fotan, N.T., HK

(73) Assignee: Specialife Industries Limited, Fotan (HK)

(21) Appl. No.: 12/505,551

(22) Filed: Jul. 20, 2009

(51) Int. Cl. B26B 19/00

(52) U.S. Cl. 30/29.5

(57) ABSTRACT

A nose hair trimmer with dual cutting edges which comprises a fixed blade with a plurality of teeth disposed on two opposite longitudinal sides thereof; a movable blade with a plurality of teeth disposed on two opposite longitudinal sides thereof, and the movable blade is driven by a driving unit to move in a linear reciprocating manner against the fixed blade so that the teeth on one side of the fixed blade and the teeth on one side of the movable blade cooperate with each other to define a first cutting edge, and the teeth on the other side of the fixed blade and the teeth on the other side of the movable blade cooperate with each other to define a second cutting edge; and a casing having a head portion in shape and size adapted to be inserted into a human nose, and the head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

### BACKGROUND OF THE INVENTION

The present invention relates to a nose hair trimmer and more particularly pertains to a nose hair trimmer with dual cutting edges.

There are two types of nose hair trimmers commonly available in the marketplace, namely rotary nose hair trimmers and linear nose hair trimmers. A rotary nose hair trimmer uses a set of small rotary blades protected by a stainless steel housing disposed at the head portion of the casing for trimming nose hair. The stainless steel housing prevents the blades from coming into direct contact with the nasal passage of a human nose and thereby making the nose hair trimmer safer to use. A linear nose hair trimmer has a movable teethed blade and a fixed teethed blade disposed at an upper end of the casing. The teeth of the movable blade and the fixed blade cooperate with each other to define a cutting edge which is substantially perpendicular to a longitudinal axis of the nasal passage of a human nose. Both the aforementioned types of nose hair trimmers could achieve nose hair trimming, but they are relatively inefficient in cutting nose hair as the area of the cutting edge is relatively small.

### BRIEF SUMMARY OF THE INVENTION

In view of the aforesaid disadvantages now present in the prior art, an object of the present invention is to provide a nose hair trimmer which has a larger area of cutting edges and therefore could reduce the time and effort for trimming nose hair.

It is another object of the present invention to provide a nose hair trimmer which is safe to operate and prevents the nasal passage of a human nose from being injured during nose hair trimming.

A further object of the present invention is to provide a nose hair trimmer which is simple in its structure and overall assembly complexity.

An even further object of the present invention is to provide a nose hair trimmer which is susceptible of a low cost of manufacture with regard to both materials and labor, and which accordingly is then susceptible of low prices of sale to the consuming public, thereby making such nose hair trimmers economically available to the buying public.

To attain this, the present invention generally comprises a fixed blade, a movable blade and a casing. The fixed blade has a plurality of teeth disposed on two opposite longitudinal sides thereof. The movable blade has a plurality of teeth disposed on two opposite longitudinal sides thereof. The movable blade is driven by a driving unit to move in a linear reciprocating manner against the fixed blade so that the teeth on one of the longitudinal sides of the fixed blade and the teeth on one of the longitudinal sides of the movable blade cooperate with each other to define a first cutting edge, and the teeth on the other longitudinal side of the fixed blade and the teeth on the other longitudinal side of the movable blade cooperate with each other to define a second cutting edge. The casing has a head portion in shape and size adapted to be inserted into a human nose. The head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

In a preferred embodiment, the two longitudinal openings are provided on two opposite sides at a lower part of the head portion, and an upper part of the head portion is used for housing a driving arm of the driving unit which is securely connected to the movable blade.

To avoid the nasal passage of the nose from being injured during nose hair trimming, the teeth of the fixed blade are each rounded at its outer end so as to reduce the sharpness of outer edges of the fixed blade. The fixed blade is of a width larger than that of the movable blade so that the teeth on the two sides of the movable blade do not extend outward of the teeth on the two sides of the fixed blade.

The fixed blade and the movable blade are substantially rectangular in shape.

In a preferred embodiment, distance between the teeth on the movable blade and the fixed blade on the first cutting edge is smaller than distance between the teeth on the movable blade and the fixed blade on the second cutting edge, so that the first cutting edge provides a finer trim and the second cutting edge provides a coarser trim. In other embodiments, distances between the teeth on the movable blade and the fixed blade on the first cutting edge and the second cutting edge may be the same.

### BRIEF DESCRIPTION OF THE DRAWINGS

FIG. 1 illustrates a perspective view of the nose hair trimmer of the first embodiment.

FIG. 2 illustrates an enlarged view of the head portion of the nose hair trimmer of the nose hair trimmer of the first embodiment.

FIG. 3 illustrates the internal structure of the head portion of the nose hair trimmer of the first embodiment.

FIG. 4a illustrates a perspective view of the fixed blade of the nose hair trimmer of the first embodiment.

FIG. 4b is a partial enlarged view of FIG. 4a.

FIG. 5 illustrates a perspective view of the movable blade of the nose hair trimmer of the first embodiment.

FIG. 6 illustrates an enlarged view of the head portion of the nose hair trimmer of the nose hair trimmer of another embodiment.

### DETAILED DESCRIPTION OF THE INVENTION

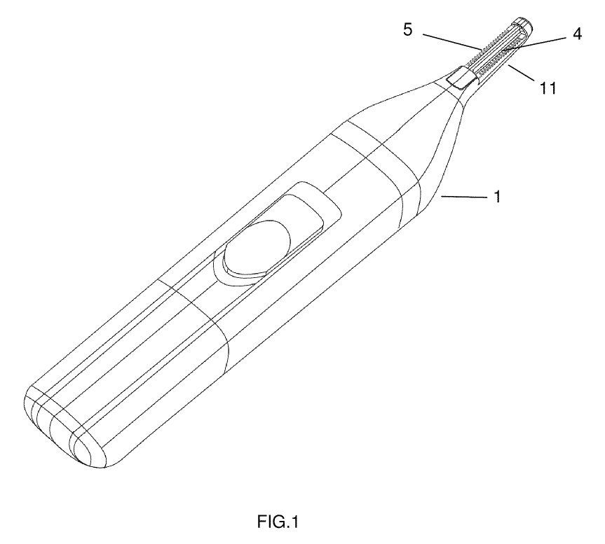

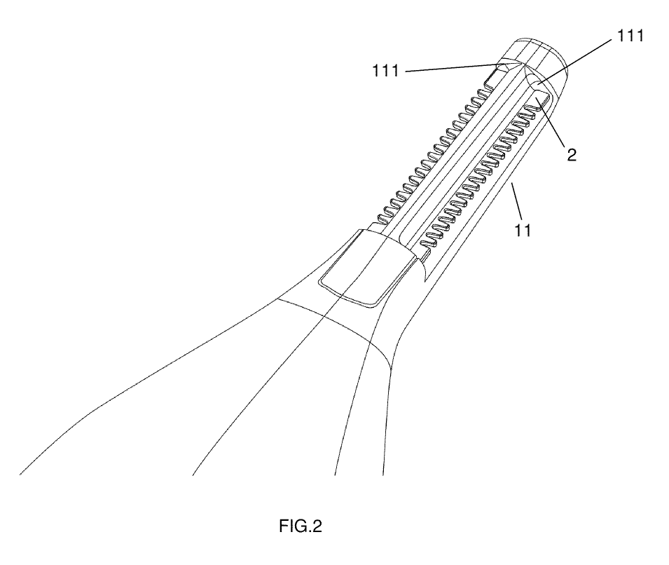

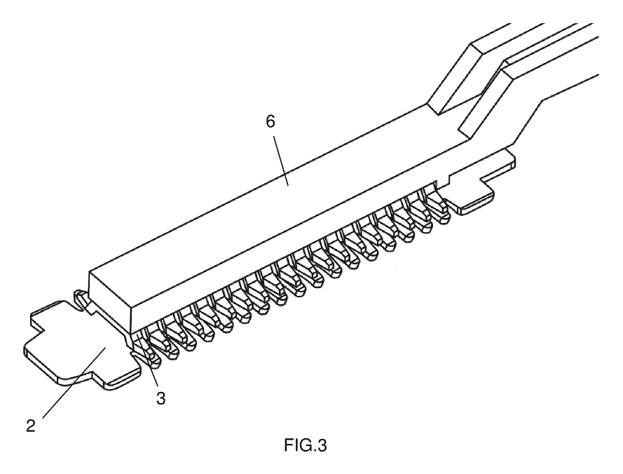

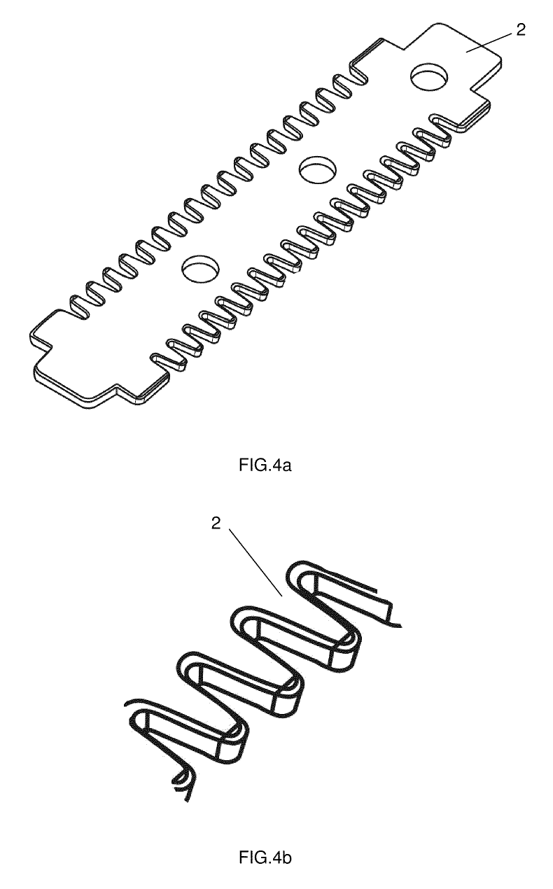

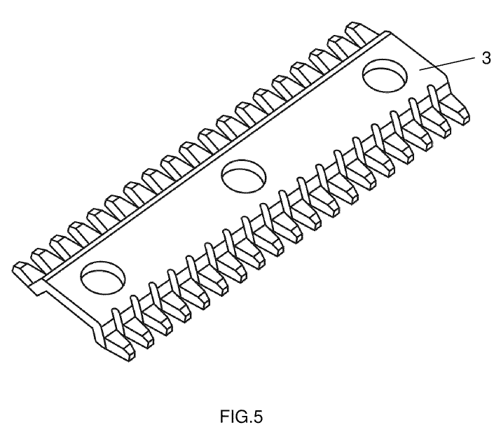

The present invention is further described in detail with the following embodiments and the accompanying drawings. As illustrated in FIGS. 1-5, the present embodiment comprises a casing 1 which has a head portion 11, a fixed blade 2 with a plurality of teeth disposed on two opposite longitudinal sides thereof, and a movable blade 3 with a plurality of teeth disposed on two opposite longitudinal sides thereof.

The movable blade 3 is driven by a driving unit to move in a linear reciprocating manner against the fixed blade 2 so that the teeth on one of the longitudinal sides of the fixed blade 2 and the teeth on one of the longitudinal sides of the movable blade 3 cooperate with each other to define a first cutting edge 4, and the teeth on the other longitudinal side of the fixed blade 2 and the teeth on the other longitudinal side of the movable blade 3 cooperate with each other to define a second cutting edge 5.

In this embodiment, the driving unit comprises a driving arm 6 which is connected to an electrically powered motor (not shown in the drawings). The driving arm 6 is securely connected to the movable blade 3 to drive the linear reciprocating movement of the movable blade 3. The structure and operation of the driving unit to drive the linear reciprocating movement of the movable blade 3 is commonly-known in the art, so the details are not further disclosed herein.

The head portion 11 is in shape and size adapted to be inserted into a human nose. Two longitudinal openings 111 are provided on two opposite sides at a lower part of the head portion 11 for exposing the teeth on the two longitudinal sides of the fixed blade 2 and the movable blade 3. The upper side of the head portion 11 is for housing the driving arm 6 of the driving unit.

In this embodiment, the fixed blade 2 and the movable blade 3 are substantially rectangular in shape. To avoid the nasal passage of the nose from being injured during nose hair trimming, the teeth of the fixed blade 2 are each rounded at its outer end so as to reduce the sharpness of outer edges of the fixed blade 2. The fixed blade 2 is of a width larger than that of the movable blade 3 so that the teeth on the two sides of the movable blade 3 do not extend outward of the teeth on the two sides of the fixed blade 2.

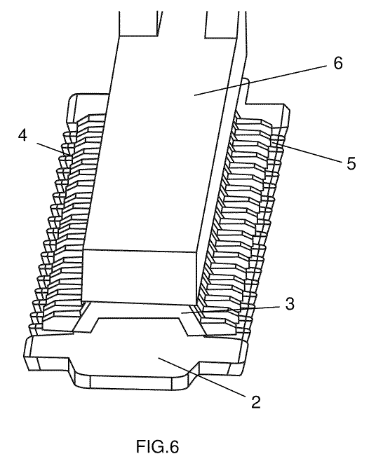

In this embodiment, distance between the teeth on the movable blade 3 and the fixed blade 2 on the first cutting edge 4 is the same as the distance between the teeth on the movable blade 3 and the fixed blade 2 on the second cutting edge 5. In other embodiment as illustrated in FIG. 6, the distance between the teeth on the movable blade 3 and the fixed blade 2 on the first cutting edge 4 may be smaller than the teeth on the movable blade 3 and the fixed blade 2 on the second cutting edge 5. As a result, the first cutting edge 4 provides a finer trim and the second cutting edge 5 provides a coarser trim.

As to a further discussion of the manner of usage and operation of the present invention, the same should be apparent from the above description. Accordingly, no further discussion relating to the manner of usage and operation is provided.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

The present invention is capable of other embodiments and of being practiced and carried out in various ways. It is to be understood that the phraseology and terminology employed herein are for the purpose of description and should not be regarded as limiting.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention.

What is claimed is:

1. A nose hair trimmer with dual cutting edges which comprises
a fixed blade with a plurality of teeth disposed on two opposite longitudinal sides thereof;
a movable blade with a plurality of teeth disposed on two opposite longitudinal sides thereof, and the movable blade is driven by a driving unit to move in a linear reciprocating manner against the fixed blade so that the teeth on one of the longitudinal sides of the fixed blade and the teeth on one of the longitudinal sides of the movable blade cooperate with each other to define a first cutting edge, and the teeth on the other longitudinal side of the fixed blade and the teeth on the other longitudinal side of the movable blade cooperate with each other to define a second cutting edge; and
a casing having a head portion in shape and size adapted to be inserted into a human nose, and the head portion is provided with two longitudinal openings disposed opposite to each other for exposing the first cutting edge and the second cutting edge respectively, so that the first cutting edge and the second cutting edge are positioned substantially parallel to a longitudinal axis of a nasal passage of a human nose when the head portion is inserted into the nose.

2. The nose hair trimmer with dual cutting edges as in claim 1, wherein the two longitudinal openings are provided on two opposite sides at a lower part of the head portion, and an upper part of the head portion is used for housing a driving arm of the driving unit which is securely connected to the movable blade.

3. The nose hair trimmer with dual cutting edges as in claim 1, wherein the teeth of the fixed blade are each rounded at its outer end so as to reduce the sharpness of outer edges of the fixed blade.

4. The nose hair trimmer with dual cutting edges as in claim 1, wherein the fixed blade is of a width larger than that of the movable blade so that the teeth on the two longitudinal sides of the movable blade do not extend outward of the teeth on the two longitudinal sides of the fixed blade.

5. The nose hair trimmer with dual cutting edges as in claim 1, wherein the fixed blade and the movable blade are substantially rectangular in shape.

6. The nose hair trimmer with dual cutting edges as in claim 1, wherein distance between the teeth on the movable blade and the fixed blade on the first cutting edge is smaller than distance between the teeth on the movable blade and the fixed blade on the second cutting edge, so that the first cutting edge provides a finer trim and the second cutting edge provides a coarser trim.

7. The nose hair trimmer with dual cutting edges as in claim 1, wherein distances between the teeth on the movable blade and the fixed blade on the first cutting edge and the second cutting edge are the same.
